(19) United States
(12) Patent Application Publication
(10) Pub. No.: US 2002/0119233 A1
(43) Pub. Date: Aug. 29, 2002

(54) Cookies with improved shelf life and process for preparing them

(76) Inventors: An Shun Huang, Chatham, NJ (US); Belkis Akpinar, Kinnelon, NJ (US); Carlos Macku, Basking Ridge, NJ (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/738,656

(22) Filed: Dec. 15, 2000

(51) Int. Cl. A23L 1/36

(52) U.S. Cl. 426/560

(57) ABSTRACT

Cookies having an extended shelf life are prepared utilizing fat-containing flavor chips to resupply the base cake portion of a cookie with important flavor components that are lost over time. A preferred chocolate chip cookie will include a continuous crumb base cake portion with a mixture of chips of different sizes dispersed therein. Some of the chips will be small and some larger. The chips comprise a continuous fat matrix, and at least some of the smaller chips will be enhanced flavor chips which comprise at least one added flavor composition in a concentration greater than present in the larger chips. In another aspect, the use of small enhanced flavor chips alone will provide the benefits of flavor extension while not providing chip perception.

### BACKGROUND OF THE INVENTION

The invention relates to improving flavor shelf life for cookies containing chocolate or other flavored chips, chips for achieving this result and the improved products and doughs for preparing them.

Fresh home-baked cookies have desirable, balanced and near-optimal flavor and texture profiles. This freshly-baked character changes over time, and the changes can be associated with staleness. Staleness in commercial cookie products can be related to a change in one or more of flavor, aroma and texture. Texture, especially for crisp cookies, can be adequately controlled for many recipes for reasonable time periods; however, flavor and aroma losses can be damaging to acceptance even where it is possible to stabilize textural changes. Unfortunately, flavor and aroma cannot be satisfactorily stabilized with known technology.

Commercial cookies are often shipped for extended distances and stored in several different locations prior to reaching store shelves, where they may again remain for days to months. Indeed, a package might be stored, opened or unopened, on a consumer's shelf for an extended period of time. Both the time and conditions of storage can cause flavor and aroma-related shelf-life complaints. The intensity of many important flavors can diminish rapidly. For example, vanilla, butter and dairy cream flavors can be lost due to one or several mechanisms, such as (1) evaporation, (2) Schiff base formation, (3) physical adsorption to proteins due to hydrogen bonding, and (4) physical adsorption to starch. See, for example: Hau, Gray and Taylor, “Binding of Volatiles to Starch”, ACS Symposium Series 633, pp. 109-117; Fischer and Widder, “How Proteins Influence Food Flavor”, Food Technology, Vol. 51, No. 1, January 1997, pp.68-70. In an attempt to better understand the practical effects of these and possibly other mechanisms on the presence of flavors in cookies as time of storage progressed, applicant ran a series of tests on freshly-baked cookies analyzing them for important flavor components. FIG. 1 is a graph schematically representing typical data taken to quantify the maintenance of significant flavor compositions from the base cake portion of a chocolate chip cookie stored at a range of ambient temperatures as time progresses. These data are consistent with sensory evaluations. As used herein, the term “base cake” means the baked cookie dough crumb of a cookie and distinguishes it from any chips, nuts or other “inclusions” within the crumb.

Cookies are provided with flavor and aroma in a number of ways. Most typically, baking the ordinary ingredients provides the flavors. Thus, the components of the dough, e.g., the flour, butter or other shortening, sugar and the like, provide major flavor contributions. For example, caramelizing sugar during the baking process provides pleasant flavor notes. Also, browning the butter and the flour create other flavors and aromas. Flavors and aromas can also be added to the dough before baking, applied to the exterior after baking or supplied as a non-baked portion such as jelly, crème, icing, or the like. It is customary to add flavor and aroma sources such as vanilla, essential oils, and other processed natural materials and synthetic flavors and aromas. See, for example: Manley, J. R.; Technology of Biscuits, Crackers and Cookies, Vol.1, pp. 114-118; 1983.

While flavors can be initially balanced in freshly-baked cookies, they become progressively out of balance. For example, butter is a preferred shortening and provides pleasant flavor and aroma notes. Unfortunately, buttery flavor and aroma notes are significantly lost or diminished before the end of the desired shelf life. The simple addition of more butter flavor to the dough prior to baking is one possible solution, but adding amounts sufficient to last long periods can provide too strong of an initial flavor. Flavor addition in this manner is also an inefficient method because high flavor losses are associated with baking. Typically, flavor and aroma losses are pronounced for the base cake portion of a cookie, which is basically a mixture of aqueous phase ingredients. There is no known way to imbue cookies with fleeting flavors and aromas, like butter and vanilla, that will provide desirable near-optimum perceptions for freshly-baked cookies that will remain for storage-challenged products.

Additional flavor can come in the form of fruit, nuts or flavor chips, such as chocolate and butterscotch chips, added to the dough which forms the base cake portion of the cookie. These additions (also called inclusions) provide flavor and textural attributes directly related to their individual characteristics. For example, chocolate chip cookies provide two distinct regions—a continuous base cake portion comprised of baked cookie dough ingredients and discrete inclusions of flavor chips—each with its own character. The addition of nuts can provide yet a third region of flavor and texture. The flavor and texture of each of these components are discernable to the consumer.

In U.S. Pat. No. 4,732,767, Seiden, et al., note that flavor transfer from a chocolate chip to the cookie crumb can have a negative effect on acceptability. They note that “chip bleed”, described as a migration of material from the chip into the dough or crumb, can mask the flavors in the crumb. They explain that some of the chocolate chip material in chocolate chip cookies may be lost from the chip itself and become part of the cookie dough, causing a darkening in color of the dough and a measurable loss of flavor in the dough—probably due to a blending of the previously distinct flavors of the crumb and chips. They note that a flavor advantage can be achieved in chocolate chip cookies by giving the base cake and chocolate chips independent flavors, instead of flavors resulting from chocolate bleed into the base cake. They propose incorporating a particular emulsifier into the dough to reduce chip bleed. This is said to form a stable oil-in-water emulsion in the dough at room temperature. In sum, they find that migration of flavor from the chips to the crumb portion of chocolate chip cookies, principally dual-texture cookies, was a problem and they endeavored to reduce it by adding an emulsifier to the unbaked dough.

The problems of flavor and aroma stability are not easily solved and too often consumers find products with flavor profiles distinctly different from what they expect. Often, disappointment with product quality will cause the consumer to stop purchasing the particular brand. Unfortunately, marketing research does not always reveal the reasons why consumers stop buying the product. And, with the current state of the art, there would be no suitable technology to solve the problem even had it been determined that simple flavor loss (characterized by variation in flavor intensity or character with time) was a key factor.

There is a need for a process for stabilizing cookie flavor and aroma and for cookies having the flavor and aroma stabilized such that the eating experience is not so greatly affected by storage times and conditions.

Flavor is a complex matter of sensory perception, and science has not yet caught up to the problems experienced in delivering consistently good products to consumers. Despite the fact that everyone has known for some time that foods become stale and are subject to flavor changes over time, there remains a need for improvements that enable stabilization of flavor, especially in chip-containing cookies.

### DISCLOSURE OF INVENTION

Accordingly, it is an object of the invention to provide a process for stabilizing cookie flavor and a cookie having the flavor stabilized such that the eating experience is less affected by storage times and conditions than when utilizing current technology.

It is another object of the invention to provide a unique cookie product having flavor chips that provide a satisfactory chocolate-eating experience and help to stabilize flavor and aroma perception in the base cake portion of the cookie and a process for preparing it.

It is a more specific object of the invention to provide a cookie containing flavor chips which aid in the maintenance of freshness perception and do so without the creation of flavor “hot spots” and to provide a process for preparing it.

It is another specific object of the invention to provide a chocolate chip cookie having improved flavor and aroma stability without adversely affecting the perception of either the chocolate chips or the base cake of the cookie and to provide a process for preparing it.

These and other objects are realized by the present invention, which provides both a process for preparing cookies with improved shelf life and the cookie products having the improved properties.

In one aspect of the invention, a process is provided for preparing flavor-chip containing cookies having an extended shelf life, the process comprising: preparing a cookie dough; and adding to the dough a mixture of chips of different sizes, some small and some larger, said chips comprising sugar in a fat matrix, and at least some of said smaller chips are enhanced flavor chips comprising at least one added flavor composition in a concentration greater than present in at least one of the base cake or the larger chips.

In another aspect the invention provides flavor-chip containing cookies having an extended shelf life, comprising: a continuous base cake portion having dispersed therein a mixture of chips of different sizes, some small and some larger, said chips comprising a continuous fat matrix, and at least some of said smaller chips being enhanced flavor chips comprising at least one added flavor composition in a concentration greater than present in at least one of the base cake or the larger chips.

In another aspect of the invention, a process is provided for preparing flavor-chip containing cookies having an extended shelf life, the process comprising: preparing a cookie dough comprising at least one added flavor composition; and adding to the dough small enhanced flavor chips, e.g., having a count of at least 7,500 per pound, said enhanced flavor chips comprising said at least one added flavor composition in an amount effective to extend the shelf life of the cookie by migrating from the chip to the base cake portion resulting from baking the dough. Preferably, said at least one added flavor will be added in a concentration greater than normally employed in flavor chips.

In yet another aspect, the invention, provides cookies having extended shelf life due to the presence of small enhanced flavor chips comprising at least one added flavor composition present in a concentration greater than normally employed in flavor chips.

Other preferred aspects of the invention will be detailed below.

### BRIEF DESCRIPTION OF THE DRAWINGS

The invention will be better understood and its advantages will become more apparent from the following detailed description, especially when read in light of the accompanying drawings, wherein:

FIG. 1 is a graph schematically representing typical data taken to quantify the maintenance of significant flavor compositions from the base cake portion of a chocolate chip cookie stored at a range of ambient temperatures as time progresses;

FIG. 2 is a graph showing that the migration of small concentrations of flavor from small chips (-▪-) dispersed in the base cake portion of a cookie to the base cake portion, can stabilize the flavor of crumb portion (-●-).

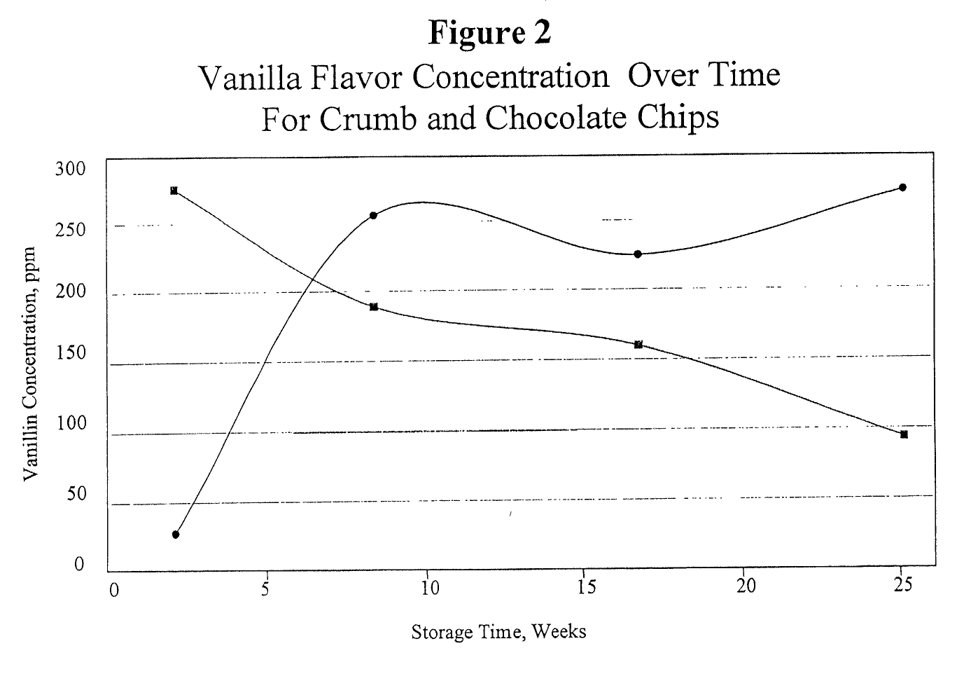

### DETAILED DESCRIPTION OF THE INVENTION

The invention will be described below with specific reference to preferred chocolate chip cookie base cake crumb and chocolate chip formulations; however, it will be clear to the experienced baker that the principles that enable improvements in these will apply to other products as well.

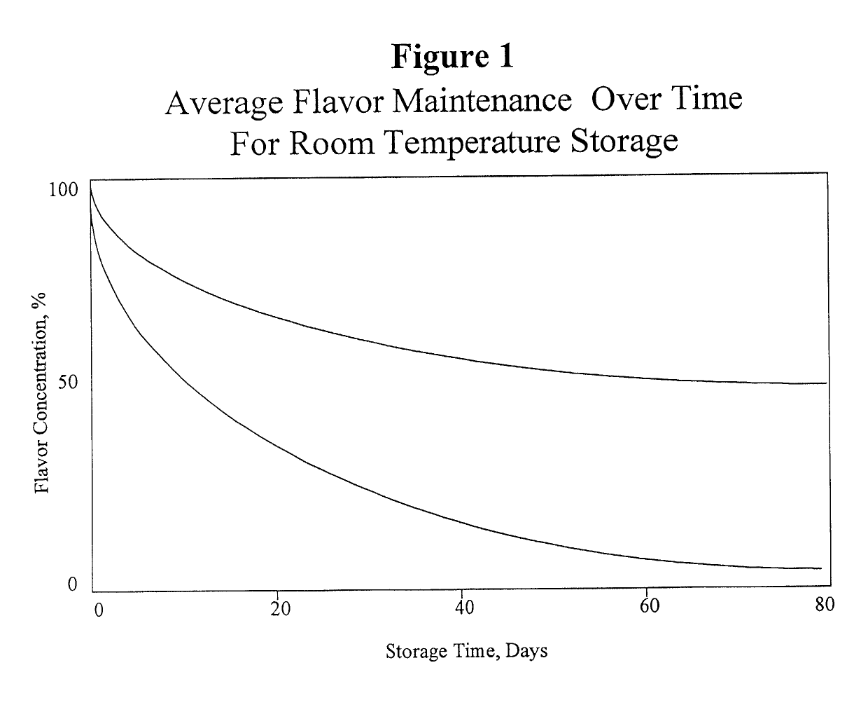

Tests have been conducted to determine the causes for perceived loss of freshness in cookies. The data shows that flavors and aromas in the base cake portion of the cookies tend to dissipate or change relatively rapidly. See FIG. 1 in this regard. More specifically, one series of tests shows that: about one third of vanilla flavor key components are lost in less than two months; about one half of butter flavor key components are lost in only a month; and, over 80% of freshness aroma is lost in a week. The invention makes significant improvements in correcting these early, unfavorable flavor changes.

As used herein, the term “cookie” is intended to include any baked product being similar to a cookie such as cookies, biscuits, small cakes, and the like. Similarly, the term “cookie dough” is intended to mean any dough or batter that is suitable for making cookies within the broadest meaning of that term. Such a dough is usually an unbaked mixture of ingredients typical for a cookie dough, comprising a starch component (e.g., flour), protein (e.g., supplied as the flour and/or as egg or the like) shortening (such as, for example, all purpose shortening, margarine or butter), sugar (e.g., sucrose, corn syrup, brown sugar, invert syrup, and the like) or other sweetener, and water for processing (e.g., supplied as water and/or some other ingredient such as milk, egg, or the like). In addition, the dough may contain a leavening agent, e.g., baking powder containing sodium bicarbonate or ammonium bicarbonate. All conventional ingredients, typical for desired recipes, can be employed. For the sake of economy of description, the entire text of Manley, J. R.; Technology of Biscuits, Crackers and Cookies, Vols. 1 and 2, is incorporated herein by reference for its descriptions of conventional ingredients and processing.

Essential to the invention is the addition to the cookie dough of discrete flavor chips comprising a continuous fat matrix and added flavoring material, e.g., chocolate chips, peanut butter chips, caramel chips, butterscotch chips, vanilla chips, coconut flavored chips, fruit flavored chips, or the like, and mixtures thereof. These flavor chips are dispersed within the dough prior to baking. Typically, chocolate chip and butterscotch chip cookies contain drops or chips of uniform composition and fairly uniform size. In a preferred form, the invention, on the other hand, employs chips in distinctly different sizes—preferably at least two different sizes, some small having enhanced flavor and some larger. In another aspect, the invention supplies small enhanced flavor chips with high concentrations of added flavors to cookies (including those not normally associated with chips) for the purpose of extending the shelf life of the cookies by maintenance of a fresh-baked cookie flavor.

For the purposes of this description, the term “flavor chip” is meant to include chocolate chips, butterscotch chips, caramel chips and any other flavored chip that is characterized by a substantially continuous fat phase, having dispersed therein a sweetener, such as a sugar and/or intensive sweetener, and flavor components such as butterscotch and ground cocoa typically supplied as cocoa liquor. The chips comprise a fat-based matrix and can be employed to incorporate both fat and water-soluble flavors. Preferably, the flavor chips will comprise sugar in the form of sucrose in a fat matrix comprised of cocoa butter or cocoa butter substitute, and the desired flavor components. It has been determined by the investigations of this invention that higher pH values for the chocolate will provide the best stability. Preferred pH values range from about 7.2 to about 8.2, e.g., from about 6.5 to about 7.2. For suitable chip formulations, reference can be had to the examples that follow and the text. Beckett, S. T., ed., Industrial Chocolate Manufacture and Use, 1968, which is hereby incorporated by reference in its entirety.

The smaller chips employed according to the invention will preferably have a count per pound of greater than about 7,500, preferably within the range of from about 7,500 to about 15,000, e.g., from about 10,000 to about 12,000. In one embodiment the count for the small chips will be at least 8,000 and in another the count can exceed 11,000. Indeed, yet smaller chips can be employed. The larger chips will have a count per pound of less than about 7,500, in some cases from about 500 to about 7,000, e.g., from about 1,000 to about 6,000. As is clear from this and is known in the art, higher counts refer to smaller chips. In U.S. Pat. No. 4,910,029, Thulin, et al., discloses that commercially-available flavor chips have particle sizes of about 1,000 to about 10,000 counts (chips) per pound. Thus, chips of commercial size can be employed for the embodiment of the invention employing two sizes of flavor chips so long as they meet the criteria of the invention. For the embodiment where only a single size, small, is employed for the sake of flavor retention without necessarily chip perception, the chips will preferably be greater than 7,500 count, e.g., at least 10,000 count. In this embodiment, chips of greater than 11,000 count, e.g., greater than 12,000 count can be employed. As a matter of example, the relative weight ratio of an average small chip (number average) to an average large chip (number average) will be at least 1:2, e.g., from about 1:5 to about 1:25. More narrowly, the ratios can be from about 1:8 to about 1:12.

Where chip perception is important, it is preferred that the smaller chips comprise at least 10%, e.g., at least 30%, by weight of the chips present in the dough and that the larger chips be employed in an amount sufficient to satisfy the consumers visual awareness that the cookies contain chips. Due to the larger size of the larger chips, it is preferred that at least one third of the weight of the chips is supplied in this form. Most preferred formulations tested to date show that the cookies should comprise at least 10%, e.g., at least 30%, of their baked weight as larger chips where chip perception is important, such as in chocolate chip cookies. The smaller chips, on the other hand, are subject to other criteria. For example, they should be there in sufficient number for uniform distribution throughout the crumb portion to achieve a measurable shelf life extension for the flavor of the cookies without creating flavor hot spots. To achieve these objectives, the small chips within the above size ranges will typically comprise at least about 3%, e.g., from 4 to 15% of the total weight of the baked cookie including chips and from about 15 to 50% by weight of the chips of all sizes employed. Weight ratios of small to large chips for some embodiments will be from 1:1 to 1:5, e.g., from 1:2 to 1:4.

At least some of the smaller chips comprise enhanced flavor chips, which comprise at least one added flavor composition in a concentration greater than present in at least one of the base cake or the larger chips. While it is typical to add some flavors to the chips in the preparation of commercial chocolate chip cookies, e.g., vanilla at a concentration of from about 0.01 to about 0.09% of the weight of chocolate chips (see, Beckett, S. T., ed., Industrial Chocolate Manufacture and Use, 1968, pp. 167-168), the levels employed according to the invention for at least a portion of the smaller chips will preferably exceed these amounts. Preferred smaller chips of the invention will contain at least one flavor in at least two times the concentration that it is employed in the larger chips. The enhanced flavor chips can comprise up to all of the smaller chips, and typically comprise at least 25%, e.g., greater than 50% by weight.

Among the suitable added flavor compositions for the flavor chips employed according to the invention, are effective flavoring amounts of at least one member selected from the group consisting of buttery flavors, vanilla flavors, cream dairy flavors, caramel-like flavors, and other flavors associated with freshness. To some extent these flavors and their perceptions overlap, but the test for whether one is present in amounts sufficient for any of these flavor effects will be best based upon suitable instrumentally derived data (e.g., gas chromatography) and expert flavor panel evaluation. Specifically identified as buttery flavors are diacetyl, acetoin, acetol, butyric acid, gamma undecalactone, gamma nonalactone, delta decalactone, acetyl methyl carbinol, lipolized butter fat and mixtures of two or more of these. Representative of vanilla flavors are vanilla bean extract, vanillin, ethyl vanillin, maltol, dihydro coumarin, heliotropin and mixtures of two or more of these. Exemplary of creamy or cream dairy flavoring are vanillin, ethyl vanillin, maple lactone, diacetyl, butyric acid, gamma undecalactone, gamma nonalactone, delta decalactone, acetyl methyl carbinol, caproic acid, lipolized butter fat and mixtures of two or more of these. Examples of caramel flavorings include vanillin, ethyl vanillin, gamma undecalactone, dihydro coumarin, caramel color and mixtures of two or more of these. Other desirable flavors can comprise any other freshness notes, such as dimethylsulfide, ethyl butyrate, bezaldehyde, butyl butyryl lactate, Oil of nutmeg, Lemon oil and the like.

The following table lists exemplary concentrations effective for chip flavors utilized according to the invention.

Parts by Weight in Flavor Chip,
ppm*

| | | Invention, |
|---|---|---|
| | Invention, | Narrow Range |
| Flavor Compound | Typical Range | (Preferred) |
| Diacetyl | 5-100 | 7-25 (10) |
| Acetoin | 1-20 | 1.5-5 (2) |
| Ethyl butyrate | 1-20 | 1.5-5 (2) |
| Ethyl lactate | 0.1-2 | 0.15-0.5 (0.2) |
| Butyric acid | 25-500 | 30-100 (40) |
| Caproic acid | 0.5-10 | .75-3 (1) |
| Bezaldehyde | 0.5-10 | .75-3 (1) |
| Butyl butyryl lactate | 0.5-10 | .75-3 (1) |
| Delta-decalactone | 0.5-10 | .75-3 (1) |
| Delta-dodecalactone | 12.5-250 | 15-25 (20) |
| Oil of nutmeg** | 0.05-5 | 0.075-1 (0.1) |
| Lemon oil** | 0.5-10 | 0.75-5 (1) |

*ppm, parts per million, weight to weight.
**Levels overlap with prior art.

Any of these flavor compositions can be employed in effective flavoring amount, and preferably at a concentration at which an expert panel would note its presence up to that where such a panel would find it too strong in the context of a chocolate chip cookie made in accordance with the invention. In one preferred form, the concentration of at least one flavor will exceed by two times the lesser of (1) the amount present in the larger chips present and (2) the normal concentration employed in chocolate chips.

As compared to cookies of any conventional formulation, it is preferred that at least of portion of the ordinary flavors normally added to the dough for forming the base cake portion of the cookie will be at least partially relocated into enhanced flavor chips. If desired, however, the dough can continue to contain its normal compliment of flavors with flavor addition to the enhanced flavor chips being a supplement to remedy flavor loss over time. In a preferred form of the invention, one or more flavoring compositions is added to enhanced flavor chips to increase the overall amount of flavor used in a cookie with the amount being sufficient to maintain the best optimum of a balanced flavor profile for the cookie over an extended shelf life, e.g., at least three months and preferably from three to six months.

Commercially-available chips or specially-formulated flavor chips may be used in the present invention. When selecting commercially-available chips for both small and large components, however, it is important to meet a criteria of the invention that at least some of said smaller chips are enhanced flavor chips which comprise at least one added flavor composition in a concentration greater than present in the larger chips.

Our tests have shown that both water-soluble (in powder or crystalline form) and oil-soluble (in liquid or powder form) flavors can be incorporated into the chips and can be released effectively into the base cake portion of a cookie to achieve the objects of the invention. The oil-soluble flavors can migrate from the chips into the shortening or other fat present in the base cake portion of the cookie. The water-soluble flavors can migrate from the chips into the moisture containing components in the base cake portion of the cookie. Typically, in cookies having moisture contents of at least 3%, it is found that the migration of the water-soluble compounds tends to migrate from the chips to the base cake more rapidly than do the oil-soluble flavors. Exact migration rates or simply their effects on flavor can be determined empirically, using the examples which follow as guides.

The flavors are added in suitable carriers or in dry form for mixing with the chip ingredients in the chip forming process. Carriers comprising glycerol, vegetable oil, triacetin, and propylene glycol have been effective. These and other carriers compatible with the chip ingredients and the flavors can be employed in any suitable concentrations to obtain uniform dispersion or mixture of the flavors into the chips. The amount of carrier necessary will vary widely, but ratios of 5:1 to 20:1 of carrier to flavor would be typical. In the case of chocolate chips, the flavor/carrier combination can be added during either the liquid conching step or following it in the viscosity adjusting step. Some flavor compositions can be added in the form of dry powders or crystalline materials. People skilled in the art of chip making will understand the addition of flavor to the chips.

The dough for forming the base cake will preferably contain, as is conventional, at least one added flavor, such as any of those listed above to impart desirable flavors. The invention improves on the conventional dough compositions, however, by adding to the chips some of the same flavors (at least one) added to the dough for migration into the crumb portion during storage following baking to provide extended freshness perception. Of course, where butter is the flavor added to the dough, it is possible for any flavor reminiscent of butter to be employed in the chips to maintain that flavor effect. This applies to other flavors as well.

The dough for forming the base cake may also contain any other kind of pieces of particulate edible matter (also referred to as food particles, non fat-continuous flavor pieces, inclusions, and morsels) that are either solid or semi/solid, e.g., fruit pieces or dehydrated fruit pieces such as of apple, banana, blueberry, cranberry, currant, date, mango, orange, pineapple, raisin, raspberry, strawberry or sultana; nuts or pieces of nuts such as pecans, hazelnuts, walnuts, peanuts or other types of nuts; hard or soft candy pieces; or mixtures of particulate flavoring ingredients. See also, the various ingredients discussed in Manley, cited above.

The cookie dough employed in the practice of the invention can be mixed and formed into a suitable preform for baking in any suitable apparatus. See, for example, the various ingredients discussed in Manley, cited above. Among suitable preforming devices are wire cutters of various design and depositors. Typically, dough extrusion and wire cutting apparatus of conventional design can be employed. One suitable, commercial dough extrusion/wire-cut apparatus is available from, for example, Meincke Food Processing Equipment A/S, Skovlunde, Denmark. The term “dough preform” or “preform” is intended to mean a portion or piece of a dough as defined above, unbaked but being suitable for baking into a final cookie.

The dough pieces or preforms may be baked in any suitable manner. For example, they can be heated within at least one temperature zone of a gas or electric radiant oven to brown the pieces and obtain baked pieces. Alternatively, they can be baked as described, for example in U.S. Pat. No. 5,945,022, to Volpe, et al. After baking, the cookies are packaged in a manner typical for the type of cookie involved. See, again, Manley, cited above.

The following examples are provided to further illustrate and explain a preferred form of the invention and are not to be taken as limiting in any regard. Unless otherwise indicated, all parts and percentages are by weight.

### EXAMPLE 1

To prepare chocolate chip cookies according to the invention, regular chocolate chips having a 5,000 count were employed along with specially formulated small enhanced flavor chips having a 10,000 count. The smaller chips had the following formulation:

| Ingredient | Weight Percent |
|---|---|
| Ground cocoa nib (chocolate liquor) | 35-45% |
| Ground sugar | 3-46% |
| Cocoa butter | 10-15% |
| Lecithin | 0.2-0.3% |
| Flavor (see below) | 0.1-2% |
| Total fat | 30-35% |

The flavor added to the smaller chips had the following formulation:

| Ingredient | Parts |
|---|---|
| Diacetyl | 10 |
| Acetoin | 2 |
| Ethyl butyrate | 2 |
| Ethyl lactate | 0.2 |
| Butyric acid | 50 |
| Caproic acid | 1 |
| Bezaldehyde | 1 |
| Butyl butyryl lactate | 1 |
| Delta-decalactone | 1 |
| Delta-dodecalactone | 25 |
| Oil of nutmeg | 0.1 |
| Lemon oil | 1 |
| Refined vegetable oil | 905.7 |
| Total | 1000 |

Chocolate chip cookie dough was made with the following ingredients (from group 1 to group 5). The dough was then baked for 10 minutes at 370° F. for 10 minutes.

| Ingredient | Weight percent |
|---|---|
| Group 1 | |
| All Purpose Shortening | 13.4% |
| lecithin | 0.3% |
| Group 2 | |
| FG Sugar | 7.5% |
| Spray dried egg | 2.0% |
| Salt | 0.2% |
| Group 3 | |
| High Fructose Corn Syrup | 8.0% |
| Liquid Fructose | 8.0% |
| Water | 2.0% |
| Group 4 | |
| Climax Flour | 30.0% |
| Sodium Bicarbonate | 0.4% |
| Ammonium Bicarbonate | 0.1% |
| Diammonium phosphate | 0.1% |
| Group 5 | |
| Regular Chocolate chip (1000 CT) | 22.0% |
| Flavored Chocolate Chip (10,000 CT) | 6.0% |
| Total dough | 100.0% |

### EXAMPLE 2

To prepare another batch of chocolate chip cookies according to the invention, regular chocolate chips having a 5,000 count were employed along with specially formulated small enhanced flavor chips having a 10,000 count. The smaller chips had the following formulation:

| Ingredient | Weight Percent |
|---|---|
| Ground cocoa nib (chocolate liquor) | 12-16% |
| Milk solids | 12-25% |
| Ground sugar | 40-55% |
| Cocoa butter | 20-24% |
| Lecithin | 0.2-0.3% |
| Flavor (Example 1) | 0.1-2% |
| Total fat | 30-35% |

The chocolate chip cookie dough was made with the following ingredients (from group 1 to group 4). The chocolate chip cookie dough was then baked at 375° F. for 12 minutes.

| Ingredients | Weight percent |
|---|---|
| Group 1 | |
| Butter/margarine blend | 8.0% |
| All Purpose shortening | 11.0% |
| Granulated Sugar | 10.5% |
| Brown sugar | 10.0% |
| Group 2 | |
| Liquid whole egg | 4.5% |
| High Fructose Corn Syrup | 4.3% |
| Vanilla | 0.1% |
| Lecithin | 0.25% |
| Molasses | 0.8% |
| Group 3 | |
| Cookie Flour | 25.3% |
| Sodium Bicarbonate | 0.24% |
| Salt | 0.25% |
| Non Fat Dry Milk | 1.5% |
| Pre-gel Starch | 1.3% |
| Group 4 | |
| Regular Chocolate Chips (1000 CT) | 16.0% |
| Flavored chocolate chips (10,000 CT) | 5.86% |
| Total Dough | 100.0% |

The above description is intended to enable the person skilled in the art to practice the invention. It is not intended to detail all of the possible modifications and variations, which will become apparent to the skilled worker upon reading the description. It is intended, however, that all such modifications and variations be included within the scope of the invention which is defined by the following claims. The claims are meant to cover the indicated elements and steps in any arrangement or sequence which is effective to meet the objectives intended for the invention, unless the context specifically indicates the contrary.

1. A process for preparing cookies containing chips having an extended shelf life, comprising:
preparing a cookie dough; and
adding to the dough a mixture of chips of different sizes, some small and some larger, said chips comprising sugar in a fat matrix, and at least some of said smaller chips are enhanced flavor chips comprising at least one added flavor composition in a concentration greater than present in the larger chips.

2. A process according to claim 1, wherein the larger chips are chocolate chips.

3. A process according to claim 1, wherein the smaller chips have a count per pound of greater than about 7,500 and the larger chips have a count per pound of less than about 7,500, and wherein the weight ratio of the average weight of the smaller chips on a number average to the weight of the larger chips on a number average is from 1:2 to 1:25.

4. A process according to claim 3, wherein the smaller chips have a count per pound of within the range of from about 10,000 to about 20,000 and the larger chips have a count per pound of from about 500 to about 6,000.

5. A process according to claim 1, wherein the smaller chips comprise at least 10% by weight of the chips present in the dough and wherein the larger chips are employed in an amount sufficient to provide a visual awareness that the cookies contain chips.

6. A process according to claim 1, wherein the added flavor composition for the enhanced flavor chips comprises an effective flavoring amount of at least one member selected from the group consisting of buttery flavors, vanilla flavors, cream dairy flavors, caramel-like flavors, and other flavors associated with freshness.

7. A process according to claim 6, wherein the added flavor composition comprises at least one member selected from the group consisting of acetoin, acetol, acetyl methyl carbinol, bezaldehyde, butyl butyryl lactate, butyric acid, caproic acid, caramel color, delta decalactone, diacetyl, dihydro coumarin, dimethylsulfide, ethyl butyrate, ethyl vanillin, gamma undecalactone, gamma nonalactone, heliotropin, lemon oil, lipolized butter fat, maltol, maple lactone, oil of nutmeg, vanilla bean extract, vanillin and mixtures of two or more of these.

8. A cookie containing chips having an extended shelf life, comprising:
a baked cookie dough containing therein a mixture of chips of different sizes, some small and some larger, said chips comprising sugar in a fat matrix, and at least some of said smaller chips are enhanced flavor chips comprising at least one added flavor composition in a concentration greater than present in the larger chips.

9. A cookie according to claim 8, wherein the enhanced flavor chips are chocolate chips having a pH within the range of from about 7.2 to 8.2.

10. A cookie according to claim 8, wherein the smaller chips have a count per pound of greater than about 7,500 and the larger chips have a count per pound of less than about 7,500.

11. A cookie according to claim 10, wherein the smaller chips have a count per pound of within the range of from about 10,000 to about 20,000 and the larger chips have a count per pound of from about 500 to about 6,000.

12. A cookie according to claim 8, wherein the smaller chips comprise at least 10% by weight of the chips present in the dough and wherein the larger chips are employed in an amount sufficient to provide a visual awareness that the cookies contain chips.

13. A cookie according to claim 8, wherein the added flavor composition for the smaller flavor chips comprises an effective flavoring amount of at least one member selected from the group consisting of buttery flavors, vanilla flavors, cream dairy flavors, caramel-like flavors, and other flavors associated with freshness.

14. A cookie according to claim 13, wherein the added flavor composition comprises at least one member selected from the group consisting of acetoin, acetol, acetyl methyl carbinol, bezaldehyde, butyl butyryl lactate, butyric acid, caproic acid, caramel color, delta decalactone, diacetyl, dihydro coumarin, dimethylsulfide, ethyl butyrate, ethyl vanillin, gamma undecalactone, gamma nonalactone, heliotropin, lemon oil, lipolized butter fat, maltol, maple lactone, oil of nutmeg, vanilla bean extract, vanillin and mixtures of two or more of these.

15. A process for preparing cookies containing chips having an extended shelf life, comprising:
preparing a cookie dough; and
adding to the dough a mixture of chips of different sizes, at least 30% by weight of the chips present in the dough being small and some larger chips, said larger chips being employed in an amount sufficient to provide a visual awareness that the cookies contain chips, said chips comprising sugar in a fat matrix, wherein the smaller chips have a count per pound of greater than about 7,500 and the larger chips have a count per pound of less than about 7,500, and at least some of said smaller chips are enhanced flavor chips comprising at least one added flavor composition in a concentration greater than present in the larger chips, said flavor comprising at least one member selected from the group consisting of buttery flavors, vanilla flavors, cream dairy flavors, caramel-like flavors, and other flavors associated with freshness.

16. A process according to claim 15, wherein the enhanced flavor chips are chocolate chips having a pH within the range of from about 7.2 to 8.2.

17. A process according to claim 15, wherein the smaller chips have a count per pound of within the range of from about 7,500 to about 15,000 and the larger chips have a count per pound of from about 500 to about 7,500, and wherein the weight ratio of the average weight of the smaller chips on a number average to the weight of the larger chips on a number average is from 1:2 to 1:25.

18. A process according to claim 15, wherein the added flavor composition comprises at least one member selected from the group consisting of acetoin, acetol, acetyl methyl carbinol, bezaldehyde, butyl butyryl lactate, butyric acid, caproic acid, caramel color, delta decalactone, diacetyl, dihydro coumarin, dimethylsulfide, ethyl butyrate, ethyl vanillin, gamma undecalactone, gamma nonalactone, heliotropin, lemon oil, lipolized butter fat, maltol, maple lactone, oil of nutmeg, vanilla bean extract, vanillin and mixtures of two or more of these.

19. A cookie containing chips and having an extended shelf life, comprising:
a baked cookie dough containing therein a mixture of chips of different sizes, at least 10% by weight of the chips present in the dough being small and some larger chips, wherein said larger chips are employed in an amount sufficient to provide a visual awareness that the cookies contain chips, said chips comprising sugar in a fat matrix, wherein the smaller chips have a count per pound of greater than about 7,500 and the larger chips have a count per pound of less than about 7,500, and at least some of said smaller chips are enhanced flavor chips comprising at least one added flavor composition in a concentration greater than present in the larger chips, said flavor comprising at least one member selected from the group consisting of buttery flavors, vanilla flavors, cream dairy flavors, caramel-like flavors, and other flavors associated with freshness, and wherein the weight ratio of the average weight of the smaller chips on a number average to the weight of the larger chips on a number average is from 1:2 to 1:25.

20. A cookie according to claim 19, wherein 16 the chips are chocolate chips, the smaller chips have a count per pound of within the range of from about 7,500 to about 15,000 and the larger chips have a count per pound of from about 500 to about 7,500, and the flavor comprises at least one member selected from the group consisting of acetoin, acetol, acetyl methyl carbinol, bezaldehyde, butyl butyryl lactate, butyric acid, caproic acid, caramel color, delta decalactone, diacetyl, dihydro coumarin, dimethylsulfide, ethyl butyrate, ethyl vanillin, gamma undecalactone, gamma nonalactone, heliotropin, lemon oil, lipolized butter fat, maltol, maple lactone, oil of nutmeg, vanilla bean extract, vanillin and mixtures of two or more of these, and wherein the weight ratio of the average weight of the smaller chips on a number average to the weight of the larger chips on a number average is from 1:2 to 1:25.

21. A process for preparing cookies having an extended shelf life, the process comprising: preparing a cookie dough comprising at least one added flavor; and adding to the dough small enhanced flavor chips, said chips comprising said at least one added flavor composition in an amount effective to extend the shelf life of the cookie by migrating from the chip to the base cake portion formed by baking the dough.

22. A process according to claim 21, wherein the small chips have a count per pound of at least about 7,500 per pound, and wherein the weight ratio of the average weight of the smaller chips on a number average to the weight of the larger chips on a number average is from 1:2 to 1:25.

23. A cookie containing chips having an extended shelf life, comprising: a continuous cookie base cake having dispersed therein small enhanced flavor chips comprising at least one flavor in a concentration greater than normally employed in flavor chips.

24. A cookie according to claim 23, wherein the small enhanced flavor chips have a count per pound of at least about 7,500 per pound, and wherein the weight ratio of the average weight of the smaller chips on a number average to the weight of the larger chips on a number average is from 1:2 to 1:25.

25. A cookie according to claim 24, wherein the enhanced flavor chips are chocolate chips having a pH within the range of from about 7.2 to 8.2.
